(19) United States
(12) Patent Application Publication
(10) Pub. No.: US 2013/0138484 A1
(43) Pub. Date: May 30, 2013

(54) METHOD FOR COMBINING A TAXI SERVICE WITH A LOTTERY GAME

(71) Applicant: Shih Pi Ta Technology Ltd., Taipei City (TW)

(72) Inventors: Jen-Chang WU, Taipei City (TW); Ming-Hung HSIEH, Taipei City (TW); Cheng-Han WU, Taipei City (TW)

(73) Assignee: SHIH PI TA TECHNOLOGY LTD., Taipei City (TW)

(21) Appl. No.: 13/687,590

(22) Filed: Nov. 28, 2012

(30) Foreign Application Priority Data
Nov. 28, 2011 (TW) 100143531

(51) Int. Cl. G06Q 30/02; G07B 15/02

(52) U.S. Cl. CPC G06Q 30/0212; G07B 15/02
USPC 705/13

(57) ABSTRACT

A method for combining a taxi service with an event when a customer takes a taxi is disclosed. The customer has a portable communication apparatus. The taxi has a car communication apparatus. The method includes sending a message of the customer having taken a taxi to an identification apparatus. Next, a determination step is performed to determine whether the customer wants to participate in the event. When the customer wants to participate in this event, a communication connection with the identification apparatus is built. Finally, a confirmation message of participating in the event is sent to the portable communication apparatus from the identification apparatus.

### RELATED APPLICATIONS

This application claims priority to Taiwan Application Serial Number 100143531, filed Nov. 28, 2011, which is herein incorporated by reference.

### TECHNICAL FIELD

The present disclosure relates to a lottery method, and more particularly to a method combining a taxi service with a lottery game.

### BACKGROUND

A lottery game is frequently used as a promotional activity for a company. This is especially the case when the company is introducing a new product into the market or is having an annual promotional sale, at which time the company may hold a lottery so that customers spend time on the new product or participate in the promotional sale.

However, in a typical lottery game, lottery tickets are handed out to people on the street. In this case, those receiving the lottery tickets are chosen at random. Therefore, the company is not able to ascertain which persons buy the new product or participate in the promotional sale. Such a method of distributing lottery tickets is ineffective. In another case, the lottery tickets are given to a customer when he or she has spent a certain amount of money. Although there is certainty with respect to the persons receiving the tickets in this case, such a method makes it necessary for customers to write their personal information on the lottery tickets by hand. This is not convenient for the customers. Moreover, it is also possible for the information to be disclosed in an undesirable manner. Therefore, some customers refuse to participate in such a lottery game.

### SUMMARY

According to one aspect of the present disclosure, a method combining a taxi service with a lottery game is provided. When a customer takes a taxi, an event message, such as a lottery game message, is sent to the customer. Such a method helps companies better target customers and thereby improve the effectiveness of distributing event tickets.

According to another aspect of the present disclosure, an identification method is provided. When a customer takes a taxi, an identification company performs an identification process to obtain information provided by the customer when he or she calls a taxi service. Such a method is convenient for both customers and companies. For example, such a method ensures that mistakes made by customers when writing information on event tickets by hand are avoided.

The present disclosure discloses a method for participating in an event when a customer takes a taxi. The customer has a portable communication apparatus. The taxi has a car communication apparatus. The method includes sending a message of customer having taken a taxi to an identification apparatus. Next, a determination step is performed to determine whether the customer wants to participate in the event. When the customer wants to participate in the event, a communication connection with the identification apparatus is built. Finally, a confirmation message of participating in the event is sent to the portable communication apparatus from the identification apparatus.

In an embodiment, the step of building a communication connection comprises building a communication connection between the portable communication apparatus and the identification apparatus. The identification apparatus generates an identification code according to a customer information transferred by the car communication apparatus. A confirmation message of participating in the event is sent to the portable communication apparatus from the identification apparatus based on the identification code.

In an embodiment, the step of building a communication connection comprises building a communication connection between the car communication apparatus and the identification apparatus. The identification apparatus generates an identification code according to a customer information transferred by the car communication apparatus. A confirmation message of participating in the event is sent to the portable communication apparatus from the identification apparatus based on the identification code.

In an embodiment, the step of building a communication connection comprises building a communication connection between the portable communication apparatus and the identification apparatus. The portable communication apparatus has an application program to automatically build the communication connection with the identification apparatus. The identification apparatus generates an identification code according to customer information transferred by the application program. A confirmation message of participating in the event is sent to the portable communication apparatus from the identification apparatus based on the identification code.

In an embodiment, the step of sending the confirmation message to the portable communication apparatus includes using a Short Message Service (SMS) to send the confirmation message, using an application program in the portable communication apparatus to send the confirmation message, or using an Internet application program to send the confirmation message.

In an embodiment, the method further comprises the customer sending a taxi service request to a dispatching apparatus. The dispatching apparatus dispatches a taxi to the customer based on the taxi service request.

In an embodiment, the method further comprises determining whether the taxi service request includes a telephone number information of the portable communication apparatus. When the taxi service request includes the telephone number information, the confirmation message of participating in the event is sent to the portable communication apparatus from the identification apparatus based on the telephone number information.

In an embodiment, the event is a lottery game.

In an embodiment, the method further comprises awarding points to the customer based on at least one of a location where the customer took the taxi, a location where the customer got out of the taxi, total miles, a message of taking the taxi or a message of getting out the taxi. The point award is linked with the telephone number of the portable communication apparatus.

In an embodiment, the method further comprises printing a coupon of stores located in the area where the customer gets out the taxi.

Accordingly, when a customer takes a taxi and the customer agrees to participate in an event, a real-time identification process is performed to obtain the customer data that is provided by the customer when he or she calls a taxi service. Subsequently, a confirmation message of participating in the event is sent to the customer. With the use of such a method, it is not necessary for the customer to write his or her information on an event ticket by hand. Therefore, the burden on the customer when desiring to participate in the event is significantly reduced. Moreover, such a method also help companies better target customers and thereby improve the effectiveness of distributing event tickets.

### BRIEF DESCRIPTION OF THE DRAWINGS

In order to make the foregoing as well as other aspects, features, advantages, and embodiments of the present disclosure more apparent, the accompanying drawings are described as follows:

FIG. 1 illustrates a schematic block diagram of a lottery game system according to an embodiment of the present disclosure.

FIG. 2 illustrates a flow chart of a lottery game method according to an embodiment of the present disclosure, in which a lottery game is combined with a taxi service.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

According to a method of the present disclosure, an event message, such as a lottery game message, is sent to a customer when the customer takes a taxi. Subsequently, a real-time identification process is performed to obtain customer data that is provided by the customer when he or she calls a taxi service. Such a method may reduce the burden placed on customers when desiring to participate in an event and also may help companies better target customers and thereby make the distribution of event tickets more effective. In the explanation to follow, a lottery game will be given by way of example. However, it is to be understood that the method can be applied to other types of events.

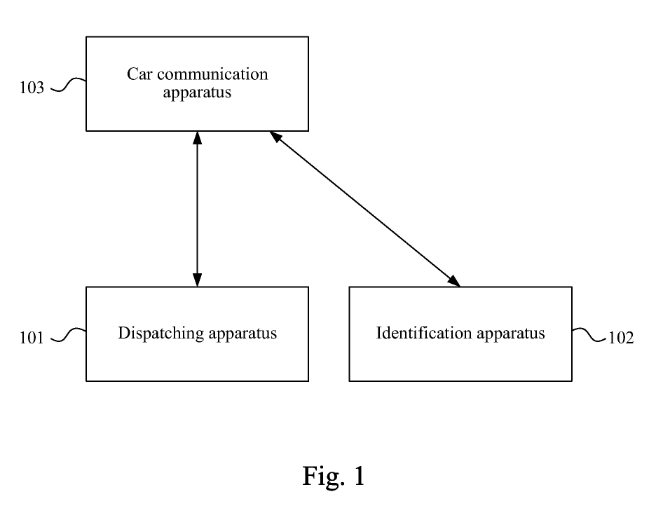

FIG. 1 illustrates a schematic block diagram of a lottery game system according to an embodiment of the disclosure. The lottery game system 100 includes a dispatching apparatus 101, an identification apparatus 102 and a car communication apparatus 103. The car communication apparatus 103 is disposed in a taxi. The dispatching apparatus 101 receives customer data and a request for a taxi service from a customer. According to the request, a taxi is dispatched to the customer by the dispatching apparatus 101. In an embodiment, the customer may use a telephone, a mobile phone, a dispatching application program in a mobile phone or a network to communicate with the dispatching apparatus 101 to send the customer data and the request. When the dispatching apparatus 101 receives the customer data and the request from the customer, a taxi is dispatched by the dispatching apparatus 101 to the customer.

When the customer takes the dispatched taxi, the car communication apparatus 103 disposed in the taxi sends information to the identification apparatus 102 to inform the identification apparatus 102 that the customer has been picked up. This information includes the location where the customer was picked up and the time that the customer was picked up. In an embodiment, the car communication apparatus 103 is an automatic vehicle location apparatus with a GPS (global positioning system) function. When the taxi driver starts the car communication apparatus 103 to calculate the taxi fare, the car communication apparatus 103 automatically sends information of the customer that was picked up to the identification apparatus 102. At this time, if the customer has agreed to participate in a lottery game when he or she sent his or her request to the dispatching apparatus 101, the identification apparatus 102 sends a confirmation message of participating in the lottery game to the customer to inform the customer that he or she is in participating in the lottery game. In an embodiment, if the customer has a portable communication apparatus, when the request is sent to the dispatching apparatus 101 from the customer, the number of this portable communication apparatus may also be sent at this time, in which case the identification apparatus 102 sends the confirmation message of participating in the lottery game to the portable communication apparatus using the number for the same.

In an embodiment, sending the confirmation message to the portable communication apparatus includes using a Short Message Service (SMS) to send the confirmation message, using an application program in the portable communication apparatus to send the confirmation message, or using an Internet application program to send the confirmation message. Sending the number of the portable communication apparatus to the dispatching apparatus 101 includes the telecommunications company directly sending the number of the portable communication apparatus to the dispatching apparatus 101, the customer telling staff at the dispatching apparatus 101 the number of the portable communication apparatus, using the application program in the portable communication apparatus to send the number of the portable communication apparatus to the dispatching apparatus 101, or using the Internet application program for calling a taxi to send the number of the portable communication apparatus to the dispatching apparatus 101.

In some instances, a customer may call the dispatching apparatus 101 to request a taxi service but will not leave the telephone number of the portable communication apparatus with the dispatching apparatus 101. In other instances, a customer may flag down a taxi in the street. That is, in such instances, the customer does not leave any contact information with the dispatching apparatus 101. In these cases, if the customer still wants to participate in the lottery game, the customer may use his or her portable communication apparatus after he or she gets in the taxi to dial a telephone number used for participating in the lottery game to thereby communicate with the identification apparatus 102. Subsequently, the customer may input his or her private information, such as a telephone number of his or her portable communication apparatus or his or her identification number, to the identification apparatus 102. In another embodiment, the customer may use his or her portable communication apparatus to start an application program or to enter a website to communicate with the identification apparatus 102 when he or she gets in a taxi. Subsequently, the customer may input his or her private information, such as a telephone number of his or her portable communication apparatus or his or her identification number, in the application program or in the website to send to the identification apparatus 102. In a further embodiment, the customer may use the car communication apparatus 103 in a taxi to communicate with the identification apparatus 102 when he or she gets in the taxi. Subsequently, the customer may input his or her private information, such as a telephone number of his or her portable communication apparatus or his or her identification number, in the car communication apparatus 103 to send to the identification apparatus 102.

When the identification apparatus 102 receives the private information of the customer, the identification apparatus 102 generates an identification code according to this private information and sends the identification code to the car communication apparatus 103 or the portable communication apparatus. Next, in an embodiment, the customer uses his or her portable communication apparatus to return this identification code to the identification apparatus 102 for reconfirmation. When the identification apparatus 102 confirms this identification code, the identification apparatus 102 generates a confirmation message of participating in the lottery game and sends the confirmation message to the customer's portable communication apparatus. In another embodiment, the customer uses the car communication apparatus 103 to return this identification code to the identification apparatus 102 for reconfirmation. In this case also, when the identification apparatus 102 confirms this identification code, the identification apparatus 102 generates a confirmation message of participating in the lottery game and sends the confirmation message to the customer's portable communication apparatus. In an embodiment, sending the confirmation message to the portable communication apparatus includes using a Short Message Service (SMS) to send the confirmation message, using an application program in the portable communication apparatus to send the confirmation message, or using an Internet application program to send the confirmation message.

It is noted that there are two possible points in time that the identification apparatus 102 can send the confirmation message to the customer's portable communication apparatus. One is after the identification apparatus 102 confirms the identification code. The other is after the identification apparatus 102 receives information that the customer has reached the destination and has exited from the taxi. The identification apparatus 102 may determine that the customer has reached the destination when the driver stops the car communication apparatus 103 to calculate the taxi fare.

Moreover, in another embodiment, the confirmation message is sent to the car communication apparatus 103 from the identification apparatus 102, which has the advantage of avoiding communication fees. The confirmation message further includes an identification code that may be used as proof that the customer is participating in the lottery game.

In some embodiments, points are awarded to the customer by a dispatching company. In an embodiment, the customer is awarded different points by the dispatching company based on a location or region where a customer takes a taxi, a location or region where a customer gets out of a taxi, total distance (in miles or kilometers) travelled by a customer in a taxi, a time that a customer takes a taxi, or a time that a customer gets out of a taxi. The awarded points link to an account of a customer. The account links to the telephone number of the customer's portable communication apparatus. In another embodiment, points are awarded to a driver by a dispatching company. The awarded points link to an account of the driver.

For example, a dispatching company may award points to a customer when the customer takes a taxi associated with the dispatching company in a first region. Accordingly, when a customer takes a taxi associated with the dispatching company in this first region, the customer may obtain award points, which for example may be used to receive a discount on the taxi fare. In another embodiment, the dispatching company may also decide to award points to a customer when the customer takes a taxi associated with the dispatching company during a special time period, such as 11:00 AM˜noon. Accordingly, when a customer takes a taxi associated with the dispatching company during this special time period, the customer may get award points, which for example may be used to receive a discount on the taxi fare.

In another embodiment, promotion information of stores is provided to the customer. For example, the car communication apparatus 103 is an automatic vehicle location apparatus with a GPS function and a printer function. In an embodiment, stores may send their GPS information to the dispatching apparatus 101. Based on the GPS information detected by the automatic vehicle location apparatus, the dispatching apparatus 101 is able to detect the location at the destination of the customer. The dispatching apparatus 101 subsequently controls the car communication apparatus 103 to print corresponding coupons or gift redemption certificates of stores located in the area of the destination for the customer. The customer can take the coupons or gift redemption certificates to buy things in the stores. In another embodiment, based on the GPS information, the dispatching apparatus 101 is able to detect the location where the customer takes the taxi. The dispatching apparatus 101 subsequently controls the car communication apparatus 103 to print coupons or gift redemption certificates of stores located at this location for the customer. The customer can take the coupons or gift redemption certificate to buy things in the stores.

In the above embodiment, the dispatching apparatus 101 can designate a special customer group to receive the coupons and gift redemption certificates. For example, the special customer group may include customers who provide their telephone number to the dispatching apparatus 101 or customers who have called a taxi service using a special number. A printer is connected to the car communication apparatus 103 to print the coupons and the gift redemption certificates of stores. In some embodiments, the stores may include those stores that are located along the route of the taxi. Because the car communication apparatus 103 has a GPS function, the dispatching apparatus 101 may know the real-time location of the taxi. In other words, when a store is located along the route of the taxi and this store also provides coupons, the dispatching apparatus 101 may control the car communication apparatus 103 to print the store's coupons for the customer. In some embodiments, information of the coupons and gift redemption certificates is sent to the portable communication apparatus or the car communication apparatus 103, so that the customer can view this information first. That is, the customer can select the coupons or gift redemption certificates that he or she desires to have printed out.

In another embodiment, the coupon or gift redemption certificate may directly be transferred to the portable communication apparatus of the customer or E-mail address. In this case, it is not necessary to print the physical coupon or gift redemption certificate. The customer information may also be sent to the stores at this time.

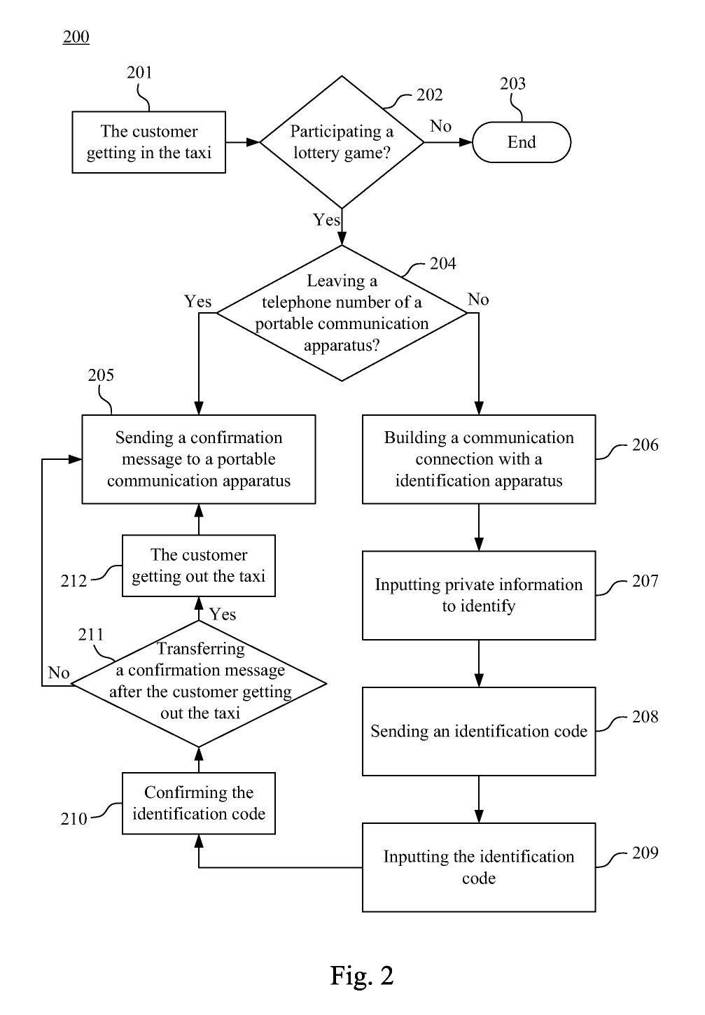

FIG. 2 illustrates a flow chart of a lottery game method according to an embodiment of the present disclosure, in which a lottery game is combined with a taxi service. Reference is made to both FIG. 1 and FIG. 2. The lottery game method 200 includes, in step 201, a customer taking a taxi. Next, in step 202, the identification apparatus 102 determines whether the customer wants to participate in a lottery game. If the customer does not want to participate in the lottery game, the lottery game process 200 is ended in step 203. In contrast, if the customer wants to participate in the lottery game, in step 204, the identification apparatus 102 determines whether the customer provided a telephone number of his or her portable communication apparatus when he or she called a taxi service.

If the customer provided a telephone number of his or her portable communication apparatus, in step 205, the identification apparatus 102 sends a confirmation message of participating in the lottery game to the customer to inform the customer that he or she is participating in the lottery game. Sending the confirmation message to the portable communication apparatus includes using a Short Message Service (SMS) to send the confirmation message, using an application program in the portable communication apparatus to send the confirmation message, or using an Internet application program to send the confirmation message.

In contrast, if the customer does not provide a telephone number of his or her portable communication apparatus, in step 206, the customer may use his or her portable communication apparatus to dial a telephone number associated with the lottery game to communicate with the identification apparatus 102 when he or she gets in a taxi. Alternatively, the customer may use his or her portable communication apparatus to start an application program or to enter a website to communicate with the identification apparatus 102 when he or she gets in a taxi. As another alternative, the customer may use the car communication apparatus 103 in the taxi to communicate with the identification apparatus 102 when he or she gets in the taxi. Subsequently, in step 207, the customer may input his or her private information, such as a telephone number of his or her portable communication apparatus or his or her identification number, to send to the identification apparatus 102.

When the identification apparatus 102 receives the private information of the customer, in step 208, the identification apparatus 102 generates an identification code according to this private information and sends the identification code to the car communication apparatus 103 or the portable communication apparatus. Next, in step 209, the customer inputs this identification code in his or her portable communication apparatus or the car communication apparatus 103, and returns this identification code to the identification apparatus 102 for reconfirmation in step 210. When the identification apparatus 102 confirms this identification code, in step 211, it is subsequently determined whether or not to send the confirmation message to the customer's portable communication apparatus after the customer gets out of the taxi. If not, step 205 is performed to send the confirmation message to the customer's portable communication apparatus. If so, on the other hand, after the identification apparatus 102 receives information that the customer has reached the destination and has gotten out of the taxi in step 212, the confirmation message is sent to the customer's portable communication apparatus in step 205. Sending the confirmation message to the portable communication apparatus includes using a Short Message Service (SMS) to send the confirmation message, using an application program in the portable communication apparatus to send the confirmation message, or using an Internet application program to send the confirmation message. The information that the customer has reached the destination and has gotten out of the taxi includes the time, the total miles and the taxi fare.

Accordingly, when a customer takes a taxi and the customer agrees to participate in a lottery game, a real-time identification process is performed to obtain the customer data that is provided by the customer when he or she calls a taxi service. Subsequently, a confirmation message of participating in the lottery game is sent to the customer. With the use of such a method, it is not necessary for the customer to write his or her information on a lottery game ticket by hand. Therefore, the burden on the customer when desiring to participate in the lottery game is significantly reduced. Moreover, such a method also helps companies better target customers and thereby improve the effectiveness of distributing lottery game tickets.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for combining a taxi service with an event when a customer takes a taxi, wherein the customer has a portable communication apparatus and the taxi has a car communication apparatus, comprising:
sending a message of the customer having taken the taxi to an identification apparatus;
determining whether the customer wants to participate in the event;
building a communication connection with the identification apparatus when the customer wants to participate in the event; and
sending a confirmation message of participating in the event to the portable communication apparatus from the identification apparatus.

2. The method of claim 1, wherein the step of building a communication connection with the identification apparatus comprises:
building a communication connection between the portable communication apparatus and the identification apparatus;
generating an identification code by the identification apparatus according to a customer information transferred by the portable communication apparatus; and
generating a confirmation message of participating in the event to send to the portable communication apparatus from the identification apparatus, wherein the confirmation message is generated according to the identification code.

3. The method of claim 1, wherein the step of building a communication connection with the identification apparatus comprises:
building a communication connection between the car communication apparatus and the identification apparatus;
generating an identification code by the identification apparatus according to a customer information transferred by the car communication apparatus; and
generating a confirmation message of participating in the event to send to the car communication apparatus from the identification apparatus, wherein the confirmation message is generated according to the identification code.

4. The method of claim 1, wherein the step of building a communication connection with the identification apparatus comprises:
building a communication connection between the portable communication apparatus and the identification apparatus, wherein the portable communication apparatus has an application program to automatically build the communication connection with the identification apparatus;
generating an identification code by the identification apparatus according to a customer information transferred by the application program; and
generating a confirmation message of participating in the event to send to the portable communication apparatus from the identification apparatus, wherein the confirmation message is generated according to the identification code.

5. The method of claim 1, wherein the step of sending the confirmation message to the portable communication apparatus includes using a Short Message Service (SMS) to send the confirmation message, using an application program in the portable communication apparatus to send the confirmation message, or using an Internet application program to send the confirmation message.

6. The method of claim 1, further comprising:
sending a taxi service request to a dispatching apparatus; and
the dispatching apparatus dispatching a taxi to the customer according to the taxi service request.

7. The method of claim 8, further comprising:
determining whether the taxi service request includes a telephone number information of the portable communication apparatus; and
sending the confirmation message of participating in the event to the portable communication apparatus from the identification apparatus according to the telephone number information when the taxi service request includes the telephone number information.

8. The method of claim 1, further comprising, before the step of sending a confirmation message, sending information of the customer getting out of the taxi to the identification apparatus.

9. The method of claim 8, wherein the information of the customer getting out of the taxi to the identification apparatus comprises a taxi fare, total miles, and a location and a time where the customer got out of the taxi.

10. The method of claim 8, further comprising printing a coupon of stores located in the area where the customer gets out of the taxi.

11. The method of claim 9, further comprising awarding points according to at least one of the taxi fare, the total miles, the location and the time where the customer got out of the taxi and a location where the customer took the taxi.

12. The method of claim 11, wherein the points are linked to the telephone number of the portable communication apparatus.

13. The method of claim 11, wherein the points are awarded to the taxi driver.

14. The method of claim 1, further comprising printing a coupon of stores located in the area where the customer got in the taxi.

15. The method of claim 1, further comprising printing a coupon of stores located along the route of the taxi.

16. The method of claim 1, where the event is a lottery game.

17. The method of claim 1, wherein the car communication apparatus comprises a printer and a GPS apparatus.

18. The method of claim 1, wherein the message of the customer having taken the taxi comprises a location and a time where the customer took the taxi.
